(19) United States
(12) Patent Application Publication
(10) Pub. No.: US 2012/0255039 A1
(43) Pub. Date: Oct. 4, 2012

(54) Protected Digital Storage Device

(76) Inventor: Keith Sipes, Santa Barbara, CA (US)

(21) Appl. No.: 13/076,588

(22) Filed: Mar. 31, 2011

(51) Int. Cl. G06F 12/16

(52) U.S. Cl. 726/35; 726/34

(57) ABSTRACT

A protected data storage device that protects data from a wireless computer network from theft and environmental conditions includes a housing having front, rear, top, and bottom walls each constructed of a rigid, fire resistant material, the housing defining an interior area. A digital storage unit is positioned in the housing interior area. A processor is situated in the housing interior area in data communication with the digital storage unit. A wireless receiver is coupled to an outer surface of a respective housing wall in data communication with the storage unit and processor. Programming in data communication with the processor causes the processor to actuate the receiver to receive data signals from the wireless network and store received data in the storage unit.

### BACKGROUND OF THE INVENTION

This invention relates generally to digital media and, more particularly, to a digital storage device that is uniquely protected against damage or spoliation from environmental emergencies such as fires and floods as well as loss from criminal activity such as theft.

Data from computers is often backed up on digital media devices such as floppy disks, compact discs, external or removable hard disk drives, flash drives, and the like. Each of these devices, including the computers themselves, suffers from several disadvantages. Certainly house fires, floods, tornados, earthquakes, and other natural disasters cause loss of precious data that is stored on computer readable media such as hard disk drives. Another major cause of data loss is theft as a result of home or business burglaries. For example, a thief may intentionally break into a person's home with the intent to steal electronic devices for financial gain but also to steal the homeowner's identity by obtaining private files and documents.

Various devices are known in the art for safeguarding valuable property, such as safes and vaults. The typical use of a safe is to protect valuables such as jewelry, cash, and other tangible personal property. Although assumably effective for their intended purposes, the existing products for the safekeeping of personal property are ineffective to protect most digital media. Specifically, the digital media listed above must be physically transferred into or out of a safe each time a backup of data from a computer is desired.

Therefore, it would be desirable to have a protected digital storage device that can automatically or periodically store data from a wireless network. In other words, it would be desirable to have a device that includes a digital storage product having a wireless antenna as well as being positioned inside a housing that is resistant to theft and natural weather events.

### SUMMARY OF THE INVENTION

The present invention includes a protected data storage device that protects data from a wireless computer network from theft and environmental conditions. The storage device includes a housing having front, rear, top, and bottom walls each constructed of a rigid, fire resistant material, the housing defining an interior area. A digital storage unit is positioned in the housing interior area. A processor is situated in the housing interior area in data communication with the digital storage unit. A wireless receiver is coupled to an outer surface of a respective housing wall in data communication with the storage unit and the processor. Programming stored in the storage unit causes the processor to actuate the receiver to receive data signals from the wireless network and store received data in a storage unit.

Therefore, a general object of this invention is to provide a digital storage device that is protected from environmental conditions such as fire and flood conditions.

Another object of this invention is to provide a digital storage device, as aforesaid, that is protected against theft.

Yet another object of this invention is to provide a digital storage device, as aforesaid, that may be secured to a building structure to prevent theft but which also includes a beacon that may be tracked in case the device is stolen or lost in a natural disaster.

A further object of this invention is to provide a digital storage device, as aforesaid, having a wireless receiver capable of receiving data signals from a wireless network so as to store data from remote computers.

A still further object of this invention is to provide a digital storage device, as aforesaid, that is cost-effective to manufacture and easy to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram of a protected digital storage device according to a preferred embodiment of the present invention;

FIG. 2 is a perspective view of the digital storage device depicted in FIG. 1;

FIG. 3 is a left side view of the digital storage device depicted in FIG. 1;

FIG. 4 is a rear view of the digital storage device depicted in FIG. 1;

FIG. 5 is a front view of the digital storage device depicted in FIG. 1;

FIG. 6 is a top view of the digital storage device depicted in FIG. 1;

FIG. 7a is a perspective view of the digital storage device as in FIG. 2 with the door in a closed configuration; and

FIG. 7b is a perspective view of the digital storage device as in FIG. 7a with the door in an open configuration.

### DESCRIPTION OF THE PREFERRED EMBODIMENT

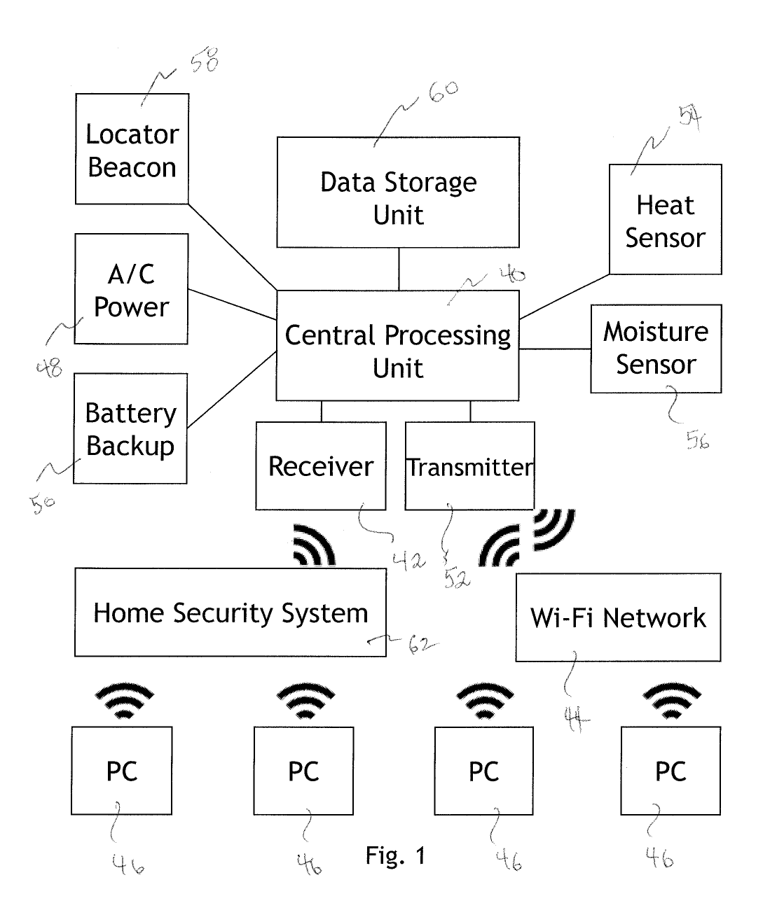

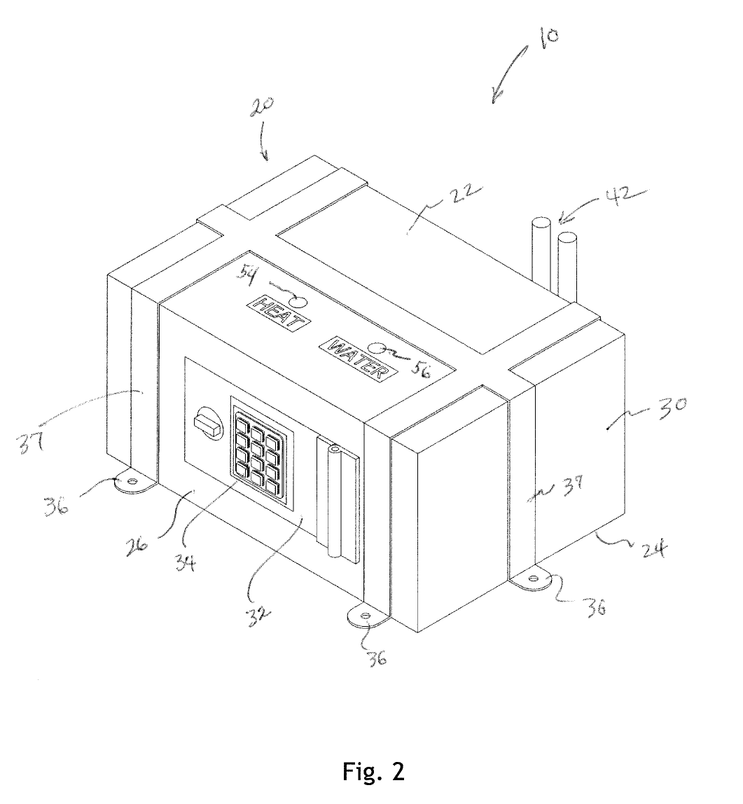

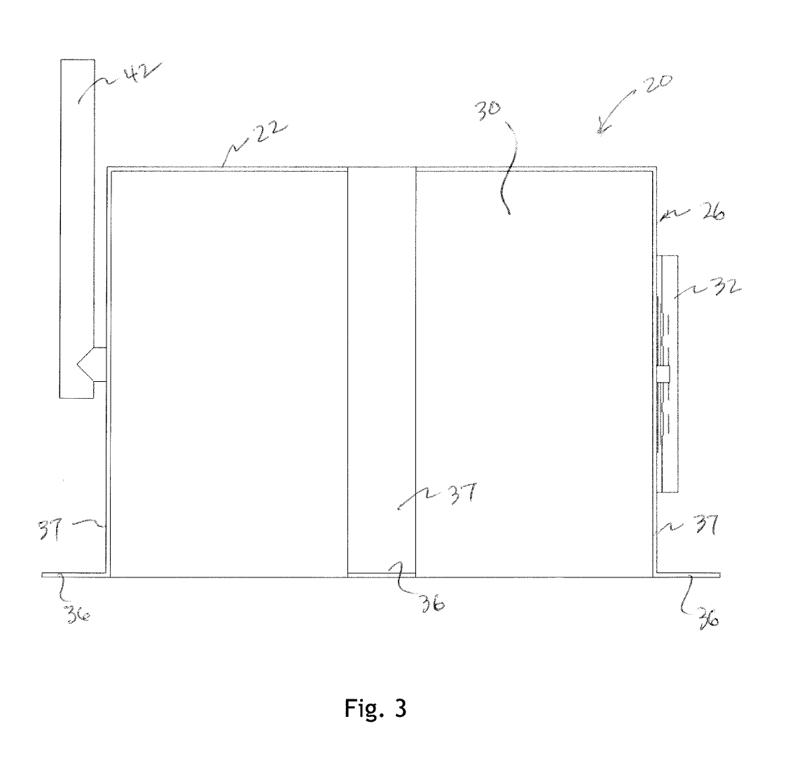

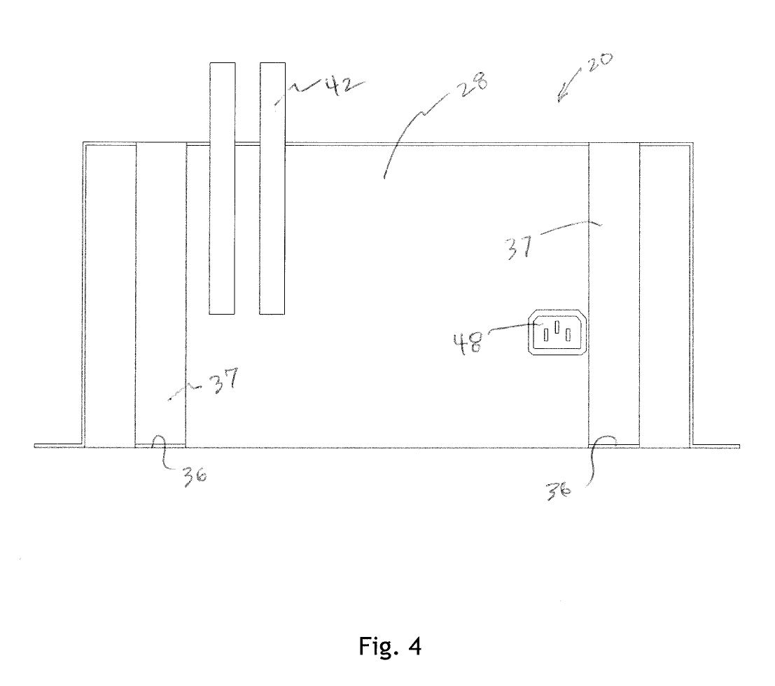

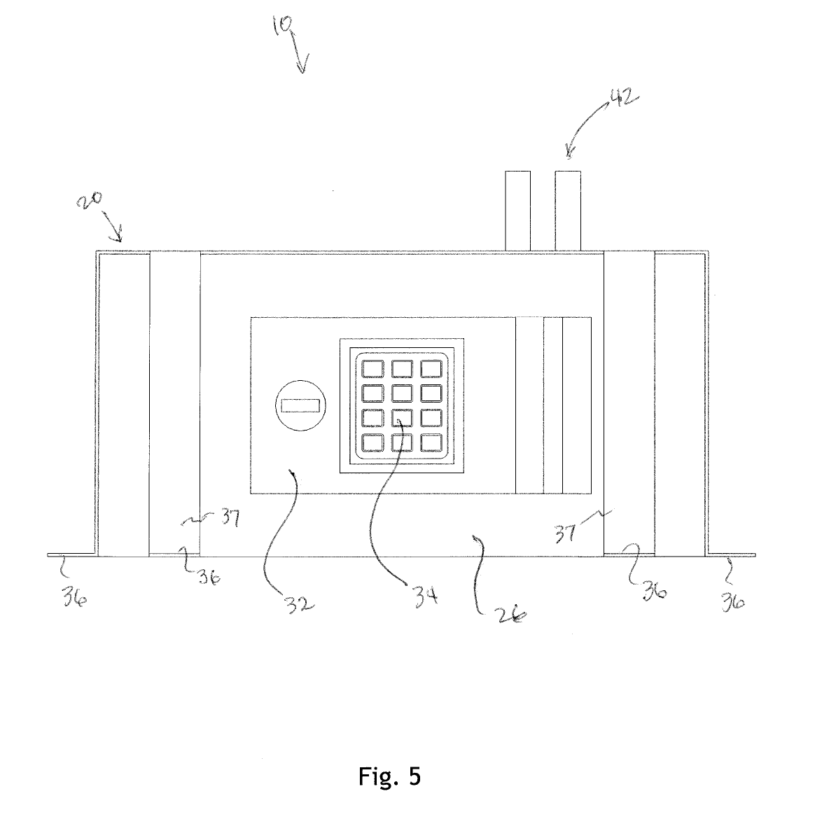

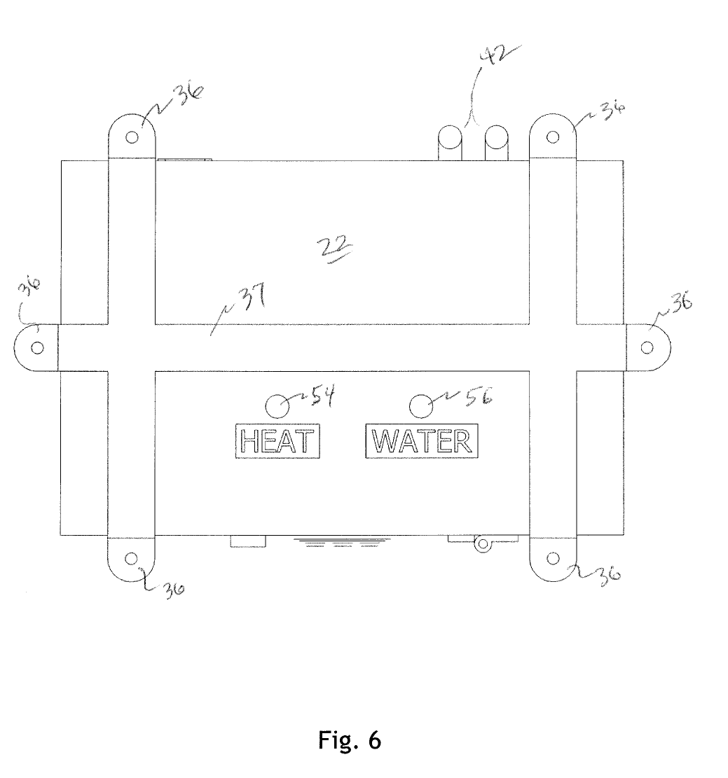

A protected digital storage device according to a preferred embodiment of the present invention will now be described in detail with reference to FIGS. 1 to 7b of the accompanying drawings. The storage device 10 includes a fire resistant and robust housing 20, a digital storage unit 60, a wireless receiver 42, and a processor 40.

The housing 20 includes top 22, bottom 24, front 26, rear 28, and side 30 walls that together define an open interior area. Each wall is constructed of a strong and rigid material that is also fire resistant. Preferably, this material is steel because of its high strength, heat resistant, and moisture resistant characteristics, although other materials meeting the stated objectives may also be utilized, such as magnesium oxide material, expanded perlite glass material, aluminum or clay brick material or the like. Further, the housing material should also be moisture resistant. A magnesium oxide material has both fire resistant and moisture resistant characteristics.

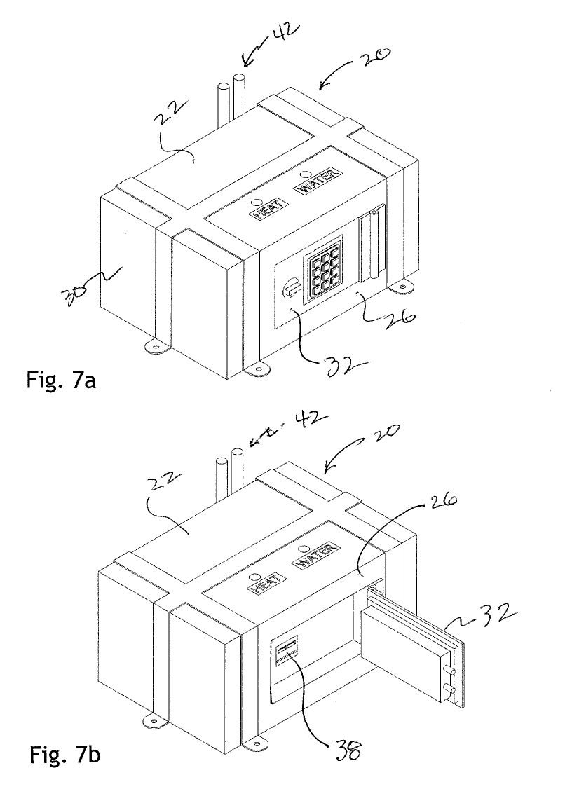

A door 32 may be pivotally coupled to a respective wall, such as to the front wall 26, and configured so as to be selectively moved between an open configuration providing access to the housing interior area (FIG. 7b) and a closed configuration preventing access to the housing interior area (FIG. 7a). A lock 34 may be operatively coupled to the door 32 so as to regulate operation of the door to authorized users only, such as a combination lock, key lock, keypad, or the like.

Further, the housing 20 may include structures by which it may be secured to a building structure such as a floor, wall, attic support beam, joist, or the like. More particularly, the securing structures may be brackets 36 that are fixedly attached to exterior surfaces of respective walls and extend outwardly therefrom. The brackets 36 may be secured to the building structures with bolts or the like. The intention of the securing brackets 36 is to make it difficult and inconvenient for the protected digital storage device 10 to be quickly or easily stolen and also to keep the device secured to a larger structure in case of a natural disaster such as a flood, fire, or tornado. The brackets 36 may also include securing bands 37 that extend substantially entirely around the entire housing exterior surface to provide extra strength and security against the housing 20 being pried away from the brackets 36 and building structure to which they are secured.

The digital storage unit 60 may be a hard disk drive or other generally high capacity memory device situated in the housing interior area. The storage unit 60 is a computer readable media device so that data stored thereon may be read by and transferred back to a computer upon demand, such as by way of a USB port 38. A plurality of programming instructions may be stored on the storage unit 60 for execution by a processor 40, the processor 40 also being positioned in the housing interior area.

A wireless receiver 42 is electrically connected to and in data communication with the processor 40 and, as a result, with the storage unit 60. The receiver 42 is configured to receive signals from a wireless network 44 that include digital data to be stored to the digital storage unit 60. The receiver 42 may also receive other signals as will be described in more detail later. The receiver 42 may include an antenna coupled to an outer surface of a respective wall of the housing 20, such as to the rear wall 28, the receiver 42 then being connected with a wire to the processor 40. It is understood that the wireless network 44 may be a Wi-Fi network that enables a plurality of computers 46 to obtain access to the internet and communicate wirelessly, as would be known to those of ordinary skill in the art.

Programming instructions stored in the storage unit 60 (a.k.a. computer readable media), when executed by the processor 40, cause the processor 40 to actuate the receiver 42 to receive data signals from the wireless network 44 and to digitally store them in the storage unit 60. It is understood that the wireless network 44 itself may be configured to initiate a backup of one or more personal computers on the network at predetermined times or at predetermined intervals of time. The receiver 42 may be configured to just receive airborne data signals whenever they are sent and to then transmit them to the processor 40 for processing whenever received. The programming instructions may regulate the manner in which the data signals are received and stored and may use a synchronization routine, as would be known to those skilled in the art of digital storage media and processors.

A power source is electrically connected to the processor 40 and may include a traditional AC power plug 48 that may be accessible, for example, through the rear wall 28. In other words, the protected storage device 10 may be plugged into an electrical plug within a residence or commercial building in order to power the electronic components described herein. The storage device 10 may also include an auxiliary power source such as a battery 50 that is configured to power the processor 40 and other electronic components in the event that the primary power source (i.e. AC electrical power) is unavailable, such as may be the case if a fire, flood, or theft is experienced.

The present invention also includes additional features that are useful in specific circumstances or when other systems are available for use in conjunction with the present system, such as a home security system 62. More particularly, the programming instructions may include specific instructions to process signals received from an associated residential or commercial security system 62. These signals are referred to herein as “security signals.” For example, a home security system 62 remote from the data storage unit 60 may be configured to transmit a security signal when it detects a potential burglary in progress or other emergency. If the security signal is received by the receiver 42, the programming may cause the processor 40 to immediately actuate the receiver 42 to receive data signals from the wireless network 44 and store the received data to the storage unit 60. This is desirable in that crucial data is saved to the protected digital storage device 10 in the event computers 46 on the network 44 are damaged or stolen as a result of the security event. In the instance described above, it is understood that the residential security system 62 may also transmit security signals to the wireless network itself to prompt an immediate backup event.

Alternatively, a transmitter 52 may be electrically connected to the processor 40 in data communication therewith. In conjunction, programming instructions may cause the processor 40 to actuate the transmitter 52 to transmit a backup request signal to the wireless network 44 if a security signal is received by the receiver 42. In other words, it is the processor 40 that proactively prompts the initiation of a backup if a security event is detected by the security system.

Further, a heat sensor 54 may be positioned outside the housing 20, such as on the top wall 22 of the housing 20, the heat sensor 54 being electrically connected to and in data communication with the processor 40. The heat sensor 54 sends temperature data to the processor 40. If the temperature data is indicative of a fire event, then specific programming instructions, when executed by the processor 40, may cause the processor 40 to actuate the transmitter 52 to send signals to prompt the wireless network 44 (and potentially a plurality of computers 46 in communication on the network) to transmit data signals to be backed up. In other words, if the processor 40 evaluates data from the heat sensor 54 to be indicative of a heat event (i.e. heat data is greater than a predetermined temperature), then the processor 40 transmits a backup request signal to prompt the wireless network 44 and any computers in communication therewith to immediately transmit data to be backed up. The processor 40 also signals the receiver 42 to receive data signals and to store them in the storage unit 60.

Further, a moisture sensor 56 may also be included outside the housing 20, such as being positioned on the top wall 22 of the housing 20, the moisture sensor 56 being electrically connected to and in data communication with the processor 40. The moisture sensor 56 sends moisture data to the processor 40. If the processor 40 determines that the moisture data is indicative of excessive moisture, such as would be indicative of a flood, then programming instructions, when executed by the processor 40, cause the processor 40 to actuate the transmitter 52 to transmit a backup request signal whereby to prompt the wireless network 44 and any computers in communication therewith to immediately transmit data to be backed up. The processor 40 also signals the receiver 42 to receive data signals and to store associated data in the storage unit 60.

An electronic beacon 58 may also be positioned inside the housing interior area and electrically connected to the power source 48 and auxiliary power source 50 (i.e. battery backup) (FIG. 1). The beacon 58 is configured to transmit intermittent locator signals in case the entire housing 20 becomes lost (such as if stolen or moved in a flood) or buried under rubble (such as in a fire or tornado).

In either of the instances described above in which a heat or moisture sensor detects fire or moisture event, respectively, programming instructions may cause the processor 40 to actuate the transmitter 52 to transmit an emergency signal to a home security system 62, thereby causing the security system 62 to notify emergency authorities such as the fire or police department.

It is understood that while certain forms of this invention have been illustrated and described, it is not limited thereto except insofar as such limitations are included in the following claims and allowable functional equivalents thereof.

1. A protected data storage device that protects data from a wireless computer network from theft and environmental conditions, comprising:
a housing having front, rear, top, bottom, and side walls each constructed of a rigid, fire resistant material, said housing defining an interior area;
a digital storage unit positioned in said housing interior area;
a processor situated in said housing interior area in data communication with said digital storage unit;
a wireless receiver coupled to an outer surface of a respective housing wall in data communication with said storage unit and said processor;
a power source electrically connected to said processor, said storage unit, and said receiver;
a plurality of programming instructions stored in said storage unit and which, when executed by said processor, cause said processor to:
actuate said receiver to receive data signals from the wireless network;
store said received data signals in said storage unit.

2. The protected storage device of claim 1, further comprising at least one bracket situated on said outer surface of said respective housing wall that is configured to selectively secure said housing to a building structure.

3. The protected storage device of claim 1, further comprising a locator beacon situated in said housing interior area and electrically connected to said power source, said locator beacon being configured to transmit intermittent location signals.

4. The protected storage device of claim 1, wherein said housing walls are constructed of steel.

5. The protected storage device of claim 1, wherein said housing includes a door pivotally coupled to said front wall, said door being movable between a closed configuration prohibiting access to said housing interior area and an open configuration providing access to said housing interior area.

6. The protected storage device of claim 5, further comprising a lock operatively coupled to said housing door configured to provide access to said housing interior area to authorized persons.

7. The protected storage device of claim 1, wherein said rigid and fire resistant material is also water resistant.

8. The protected storage device of claim 7, wherein said power source is A/C electrical power.

9. The protected storage device of claim 8, further comprising an auxiliary power source connected to said power source, said auxiliary power source being a battery.

10. The protected storage device of claim 1, further comprising programming instructions that, when executed by said processor, cause said processor to:
receive security signals from a remote security system;
if said security signals received from said remote security system are indicative of an emergency, immediately actuate said receiver to receive data signals from the wireless network;
store said received data signals in said storage unit.

11. The protected storage device as in claim 1, further comprising:
a transmitter situated in said housing interior area and in data communication with said processor;
wherein said programming instructions, when executed by said processor cause said processor to:
receive security signals from a remote security system;
if said security signals received from said remote security system are indicative of an emergency, actuate said transmitter to transmit a backup request signal configured to prompt computers connected to the wireless network to immediately transmit data signals to be backed up;
if said transmitter has transmitted a backup request signal, actuate said receiver to receive data signals from the wireless network; and
store said received data signals in said storage unit.

12. The protected storage device of claim 1 further comprising:
a heat sensor situated outside said housing interior area and in data communication with processor;
a transmitter situated in said housing interior area and in data communication with said processor;
wherein said programming instructions, when executed by said processor, cause said processor to:
if said heat sensor indicates a predetermined temperature, actuate said transmitter to transmit a backup request signal configured to prompt computers connected to the wireless network to immediately transmit data signals to be backed up;
if said transmitter has transmitted a backup request signal, actuate said receiver to receive data signals from the wireless network; and
store said received data signals in said storage unit.

13. The protected storage device of claim 12, further comprising:
a moisture sensor situated outside said housing interior area and in data communication with processor;
wherein said programming instructions, when executed by said processor, cause said processor to:
if said moisture sensor indicates a predetermined moisture level, actuate said transmitter to transmit a backup request signal configured to prompt computers connected to the wireless network to immediately transmit data signals to be backed up;
if said transmitter has transmitted a backup request signal, actuate said receiver to receive data signals from the wireless network; and
store said received data signals in said storage unit.

14. The protected storage device of claim 1, further comprising:
a moisture sensor situated outside said housing interior area and in data communication with processor;
a transmitter situated in said housing interior area and in data communication with said processor;
wherein said programming instructions, when executed by said processor, cause said processor to:
if said moisture sensor indicates a predetermined moisture level, actuate said transmitter to transmit a backup request signal configured to prompt computers connected to the wireless network to immediately transmit data signals to be backed up;
if said transmitter has transmitted a backup request signal, actuate said receiver to receive data signals from the wireless network; and
store said received data signals in said storage unit.

15. The protected storage device of claim 1, further comprising:
a heat sensor situated outside said housing interior area and in data communication with processor;
a transmitter situated in said housing interior area and in data communication with said processor;
wherein said programming instructions, when executed by said processor, cause said processor to:
if said heat sensor indicates a predetermined temperature, actuate said transmitter to transmit an emergency alert signal configured to prompt a security system to take emergency alert actions.

16. The protected storage device of claim 1, further comprising:
a moisture sensor situated outside said housing interior area and in data communication with processor;
a transmitter situated in said housing interior area and in data communication with said processor;
wherein said programming instructions, when executed by said processor, cause said processor to:
if said moisture sensor indicates a predetermined moisture level, actuate said transmitter to transmit an emergency alert signal configured to prompt a security system to take emergency alert actions.

17. The protected storage device as in claim 1, further comprising:
at least one bracket situated on said outer surface of said respective housing wall that is configured to selectively secure said housing to a building structure;
a locator beacon situated in said housing interior area and electrically connected to said power source, said locator beacon being configured to transmit intermittent location signals;
wherein:
said housing walls are constructed of steel;
said housing includes a door pivotally coupled to said front wall, said door being movable between a closed configuration prohibiting access to said housing interior area and an open configuration providing access to said housing interior area;
said door includes a lock configured to provide access to said housing interior area only to authorized persons;
said rigid and fire resistant material is also water resistant; and
said power source is an A/C electrical power.

18. The protected storage device of claim 17 further comprising an auxiliary power source connected to said power source, said auxiliary power source being a battery.

19. The protected storage device of claim 18, further comprising programming instructions that, when executed by said processor, cause said processor to:
receive security signals from a remote security system;
if said security signals received from a remote security system are indicative of an emergency, immediately actuate said receiver to receive data signals from the wireless network;
store said received data signals in said storage unit.

20. The protected storage device as in claim 19, further comprising:
a transmitter situated in said housing interior area and in data communication with said processor;
wherein said programming instructions, when executed by said processor cause said processor to:
receive security signals from a remote security system;
if said security signals received from a remote security system are indicative of an emergency, actuate said transmitter to transmit a backup request signal configured to prompt computers connected to the wireless network to immediately transmit data signals to be backed up;
if said transmitter has transmitted a backup request signal, actuate said receiver to receive data signals from the wireless network; and
store said received data signals in said storage unit.
